(19) United States
(12) Patent Application Publication
(10) Pub. No.: US 2015/0070827 A1
(43) Pub. Date: Mar. 12, 2015

(54) TOUCH DISPLAY MODULE

(71) Applicants: Chun-Yu Hsiao, Taipei City (TW); Sen-Tai Huang, Taipei City (TW); Yung-Hung Teng, Taipei City (TW)

(72) Inventors: Chun-Yu Hsiao, Taipei City (TW); Sen-Tai Huang, Taipei City (TW); Yung-Hung Teng, Taipei City (TW)

(73) Assignee: COMPAL ELECTRONICS, INC., Taipei City (TW)

(21) Appl. No.: 14/476,760

(22) Filed: Sep. 4, 2014

(30) Foreign Application Priority Data
Sep. 6, 2013 (TW) 102132258

(51) Int. Cl. G06F 1/16

(52) U.S. Cl. CPC G06F 1/1643
USPC 361/679.27

(57) ABSTRACT

A touch display module is suitable for being assembled to a back cover of an electronic apparatus. The touch display module includes a frame, a display unit and a touch unit. The frame has a first supporting surface and a second supporting surface. The display unit is supported on the second supporting surface. The touch unit is supported on the first supporting surface and adhered to the display unit and the first supporting surface. The display unit is held between the second supporting surface and the touch unit.

### CROSS-REFERENCE TO RELATED APPLICATION

This application claims the priority benefit of Taiwan application serial no. 102132258, filed on Sep. 6, 2013. The entirety of the above-mentioned patent application is hereby incorporated by reference herein and made a part of this specification.

### BACKGROUND

1. Field of the Invention

The invention relates to a display module, more particularly, to a touch display module.

2. Description of Related Art

As information technology, wireless mobile communication and information appliances have been rapidly developed and applied, to achieve more convenience, more compact and light volume and more user-friendly designs, various information products have changed from using conventional input devices such as key boards or mice to using touch devices. Due to the interface user-friendly advantage, touch panels have been widely applied in various electronic products, especially in mobile electronic products such as mobile phones, tablet computers. Based on differences in the sensing principles, the touch panels can be categorized into resistive touch panels, capacitive touch panels and optical touch panels. Among them, the capacitive touch panels now have become the mainstream of touch panels as they are characterized by better a sensing effect.

Typically, a touch display module includes a display unit and a touch unit. The display unit is fixed on a frame, and the frame surrounds the display unit. The touch unit is adhered and fixed to the display unit to form a touch display module using an adhesive material, such as double-sided adhesive tape or the like, and then the touch display module is fixed to a casing. Nevertheless, the assembly process is complicated and leads to defects, such as the increase of assembly tolerance and assembly offset.

Taiwan patent publication, No. 201037396, discloses a touch-control display device, which utilizes a two-piece frame to fix the display unit and the touch unit respectively, and the frame has an inner frame to fix the display module and an outer frame to fix the touch unit.

### SUMMARY

The invention provides a touch display module capable of decreasing an assembly tolerance between a display unit and a touch unit to reduce an offset amount of the assembly.

The invention provides a touch display module, suitable for being assembled to a back cover of an electronic apparatus. The touch display module includes a frame, a display unit and a touch unit. The frame has a first supporting surface and a second supporting surface and is disposed on the back cover. The display unit is supported on the second supporting surface. The touch unit is supported on the first supporting surface and adhered to the display unit and the first supporting surface. The display unit is held between the second supporting surface and the touch unit.

In an embodiment of the invention, the frame includes a first supporting portion and a second supporting portion. The first supporting portion has a accommodating slot, and the first supporting surface is located on the first supporting portion, and the display unit is located in the accommodating slot. The second supporting portion is connected with the first supporting portion and located in the accommodating slot. The second supporting surface is located on the second supporting portion.

In an embodiment of the invention, the second supporting portion includes an opening and is held between the display unit and the back cover, such that the opening forms a buffer space.

In an embodiment of the invention, the frame further includes reinforcing ribs and fixing portions. The reinforcing ribs are connected to a side surface of the first supporting portion. The fixing portions are connected to the side surface of the first supporting portion.

In an embodiment of the invention, the fixing portions further includes at least one frame locking portion and at least one frame fastening portion. The frame locking portion extends from the side surface of the first supporting portion and is suitable for being locked with at least one back cover locking portion of the back cover. The frame fastening portion extends from the side surface of the first supporting portion. The touch display module is suitable for being fastened onto the back cover using the frame fastening portion.

In an embodiment of the invention, the frame further has an extension portion extending from the first supporting portion and structurally locked with the back cover.

In an embodiment of the invention, the touch unit has a touch surface, the extension portion has a frame surface, and the touch surface is flush with the frame surface.

In an embodiment of the invention, the touch display module further includes a decorative sheet attached to the touch surface and the frame surface.

In an embodiment of the invention, the touch display module further includes an adhesive layer disposed on the touch unit. The touch unit is adhered to the first supporting surface and the display unit using the adhesive layer.

In an embodiment of the invention, the display unit includes a display panel and a backlight module. The display panel is adhered to the touch unit, and the backlight module is assembled to the display panel and supported on the second supporting surface.

In an embodiment of the invention, the electronic apparatus includes a first body and a second body pivoted to the first body. The second body includes the back cover and the touch display module. The touch display module includes the frame, the display unit and the touch unit.

Based on the above, in the invention, the display unit and the touch unit of the touch display module can be fixed with each other by the frame. The display unit is supported on the second supporting surface of the frame, the touch unit is supported on the first supporting surface of the frame, and the touch unit is adhered to the display unit and to the first supporting surface, such that during an assembly process of the touch display module of the invention, tolerance accumulation can be decreased so as to reduce an offset amount of the assembly.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a touch display module applied to an electronic apparatus according to an embodiment of the invention.

FIG. 1B is a partially cross-sectional diagram of the touch display module depicted in FIG. 1A along line A-A.

FIG. 1C is a partially enlarged diagram illustrating the region surrounded by a dotted line in FIG. 1B with the front bezel and the decorative sheet being removed.

FIG. 2A is a schematic diagram illustrating the touch display module of FIG. 1A disposed on the back cover.

FIG. 2B is a partially enlarged diagram illustrating the region surrounded by a dotted line in FIG. 2A.

FIG. 3A is a schematic diagram of a touch display module applied to the electronic apparatus according to another embodiment of the invention.

FIG. 3B is a schematic diagram of a touch display module applied to the electronic apparatus according to yet another embodiment of the invention.

FIG. 3C is a schematic diagram of a touch display module applied to the electronic apparatus according to still another embodiment of the invention.

### DESCRIPTION OF EMBODIMENTS

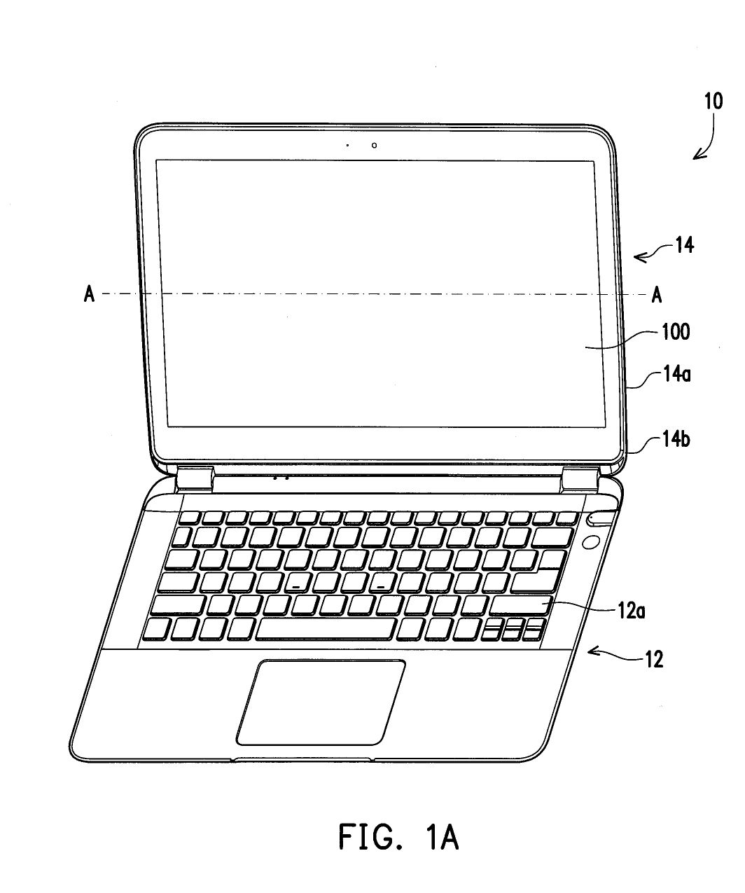

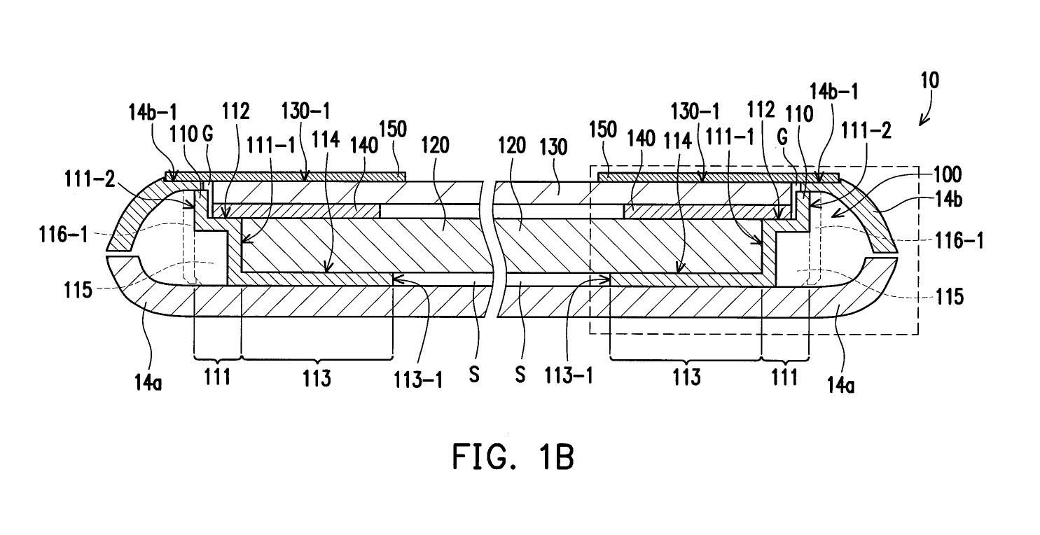

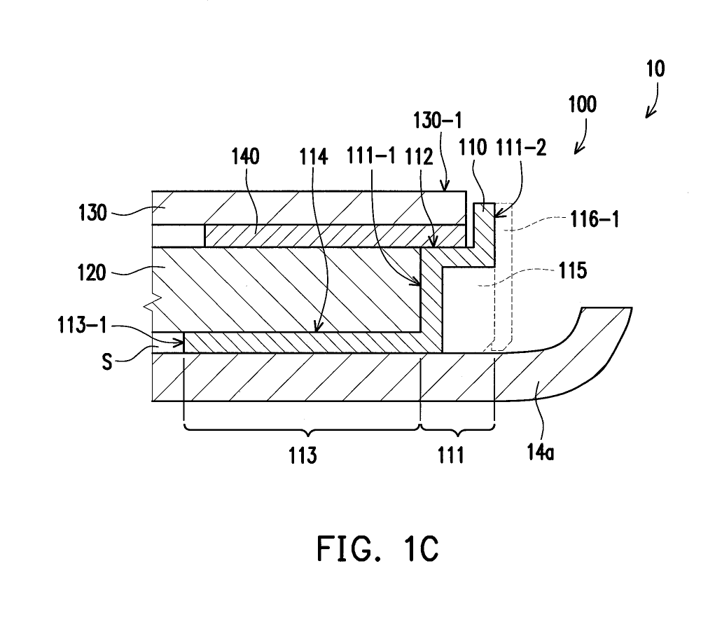

FIG. 1A is a schematic diagram of a touch display module applied to an electronic apparatus according to an embodiment of the invention. FIG. 1B is a partially cross-sectional diagram of the touch display module depicted in FIG. 1A along line A-A. FIG. 1C is a partially enlarged diagram illustrating the region surrounded by a dotted line in FIG. 1B with the front bezel and the decorative sheet being removed. With reference to FIG. 1A through FIG. 1C, an electronic apparatus 10 applied with a touch display module 100 of the present embodiment includes a first body 12 and a second body 14. The second body 14 is movably connected (e.g., pivoted) to the first body 12. The second body 14 includes a back cover 14a and a front bezel 14b. The touch display module 100 is assembled to the back cover 14a and surrounded by the front bezel 14b. The touch display module 100 includes a frame 110, a display unit 120 and a touch unit 130. The frame 110 is disposed on the back cover 14a. The display unit 120 is supported on the frame 110. The touch unit 130 is also supported on the frame 110 and adhered to the display unit 120 and the first supporting surface 112. The display unit 120 is held between the second supporting surface 114 and the touch unit 130.

In the present embodiment, the frame 110 has a first supporting surface 112 and a second supporting surface 114. The display unit 120 is supported on the second supporting surface 114. The touch unit 130 is supported on first supporting surface 112 and also adhered to the display unit 120 and the first supporting surface 112. The aforementioned adhering manner is, for example, disposing an adhesive layer 140 on the touch unit 130, such that the touch unit 130 is adhered to the first supporting surface 112 and the display unit 120 using the adhesive layer 140. It should be noticed that the display unit 120 and the touch unit 130 may be adhere to each other and assembled to the same frame 110, such that tolerance accumulation of the touch display module 100 during the assembly process may be decreased to reduce an offset amount of the assembly.

The frame 110 includes a first supporting portion 111 and a second supporting portion 113. The first supporting portion 111 has an accommodating slot 111-1, the first supporting surface 112 is located on the first supporting portion 111, and the display unit 120 is located in the accommodating slot 111-1 and surrounded by the first supporting portion 111. The second supporting portion 113 is connected with the first supporting portion 111 and located in the accommodating slot 111-1. The second supporting surface 114 is located on the second supporting portion 113. When the touch display module 100 is assembled to the back cover 14a, the second supporting portion 113 contacts the back cover 14a. In the present embodiment, the second supporting portion 113 includes an opening 113-1 and is held between the display unit 120 and the back cover 14a, such that the opening 113-1 forms a buffer space S. When the back cover 14a of the electronic apparatus 10 is subjected to a force from the external, the buffer space S is capable of absorbing impact from the external so as to prevent the display unit 120 from being directly affected by the external force.

In the present embodiment, the touch display module 100 further includes a decorative sheet 150. The decorative sheet 150 is attached onto the touch unit 130 and the front bezel 14b and covers a gap G between the touch unit 130 and the front bezel 14b so as to maintain an aesthetic appearance. To be more specific, the touch unit 130 has a touch surface 130-1, the front bezel 14b has a front bezel surface 14b-1, and the touch surface 130-1 is flush with the front bezel surface 14b-1. The decorative sheet 150 is attached to the touch surface 130-1 and the front bezel surface 14b-1. Additionally, the decorative sheet 150 may have different appearance designs according to design demands, but the invention is not limited thereto.

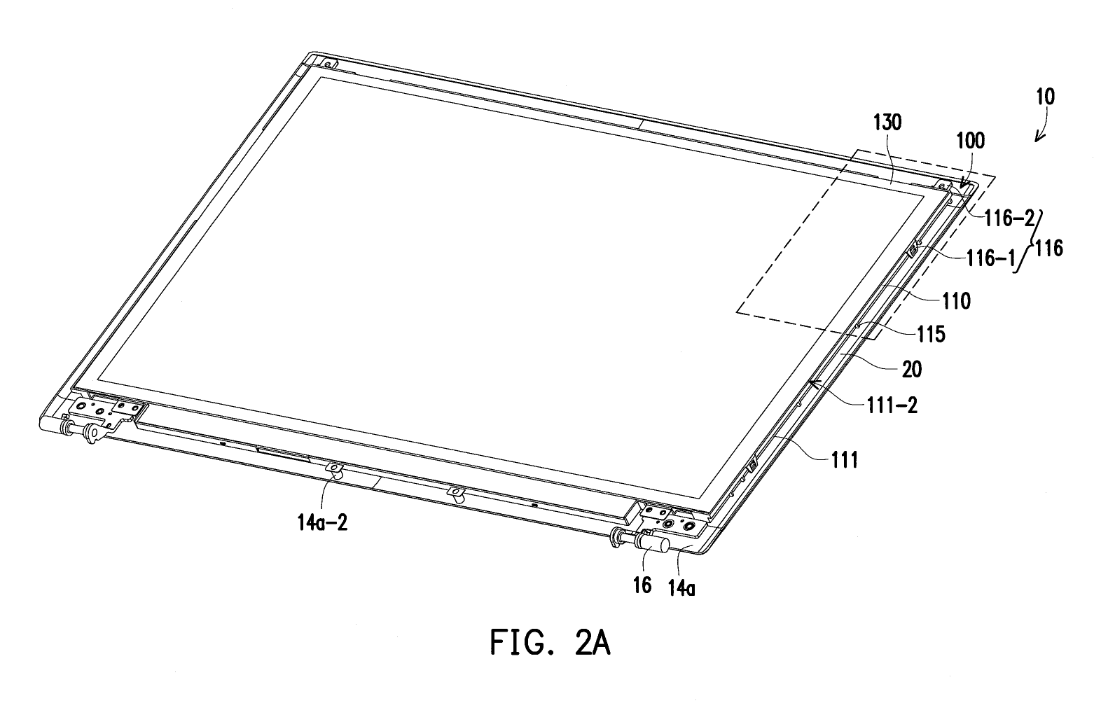

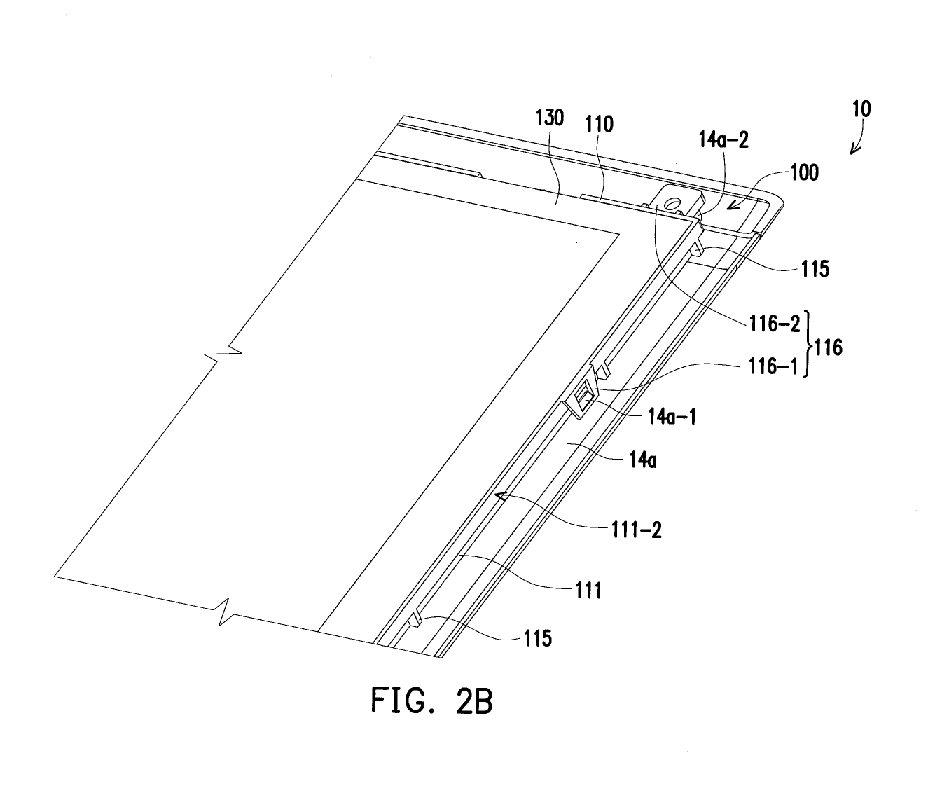

FIG. 2A is a schematic diagram illustrating the touch display module of FIG. 1A disposed on the back cover. FIG. 2B is a partially enlarged diagram illustrating the region surrounded by a dotted line in FIG. 2A. With reference to FIG. 1A, FIG. 2A and FIG. 2B, in the present embodiment, the frame 110 may further include a plurality of reinforcing ribs 115 and a plurality of fixing portions 116. The reinforcing ribs 115 are connected to a side surface 111-2 of the first supporting portion 111. The fixing portions 116 are connected to a side surface 111-2 of the first supporting portion 111.

When the touch display module 100 is applied to an electronic apparatus 10, such as a notebook computer (NB), the first body 12 is, for example, an NB host including a keyboard 12a, and the second body 14 is a display screen of the NB. The electronic apparatus 10 further includes a hinge 16 connected between the first body 12 and the second body 14. When a user applies a force on the second body 14 relatively to the first body 12, with the disposition of the hinge 16, the second body 14 is capable of being opened or closed relatively to the first body 12. When the user rotates the second body 14 relatively to the first body 12 for operation, the touch display module 100 is easily subjected to the external force and deformed.

For preventing the touch display module 100 from being deformed easily due to the external force, in the conventional art, a reinforcing element is disposed below the frame 110, or the hinge 16 is extended to a place below the frame 110 to reinforce rigidity of the frame 110. However, comparing with the conventional art, the frame 110 of the present embodiment may improve the rigidity of the frame 110 with the reinforcing ribs 115 protruding from the frame 110. Thus, the touch display module 100 of the present embodiment does not need to the reinforcing element additionally disposed to the frame 110 like the conventional art does and thus, can lower down production cost.

In the present embodiment, the touch display module 100 is capable of being fixed onto the back cover 14a of the second body 14 using the fixing portions 116. The fixing portions 116 may include one or more frame locking portions 116-1 (which are illustrated as two in FIG. 2A) and one or more frame fastening portions 116-2 (which are illustrated as four in FIG. 2A). The frame locking portions 116-1 extend from the side surface 111-2 of the first supporting portions 111 and are suitable for being locked with at least one back cover locking portion 14a-1 (illustrated in FIG. 2B) of the back cover 14a. The frame fastening portions 116-2 extend from the side surface 111-2 of the first supporting portions 111, such that the frame 110 is suitable for being fastened to at least one back cover fastening portion 14a-2 (illustrated in FIG. 2B) of the back cover 14a using the frame fastening portion 116-2. When the touch display module 100 is assembled to the back cover 14a, the frame locking portion 116-1 is locked with the back cover locking portion 14a-1. The frame fastening portion 116-2 and the back cover fastening portion 14a-2 are flush with each other and fastened to each other using a locking element (e.g., a screw) so as to fix the frame 110 onto the back cover 14a.

A material of the frame 110 is, for example, plastic, and the reinforcing ribs 115 and the fixing portions 116 (i.e., the frame locking portions 116-1 and the frame fastening portions 116-2) of the frame 110 may be fabricated together with the frame 110 by using a plastic injection molding method. Additionally, the frame 110 may also be made of a metal material, such as stainless steel formed by stamping or magnesium aluminum material formed by casting, but the invention is not limited thereto.

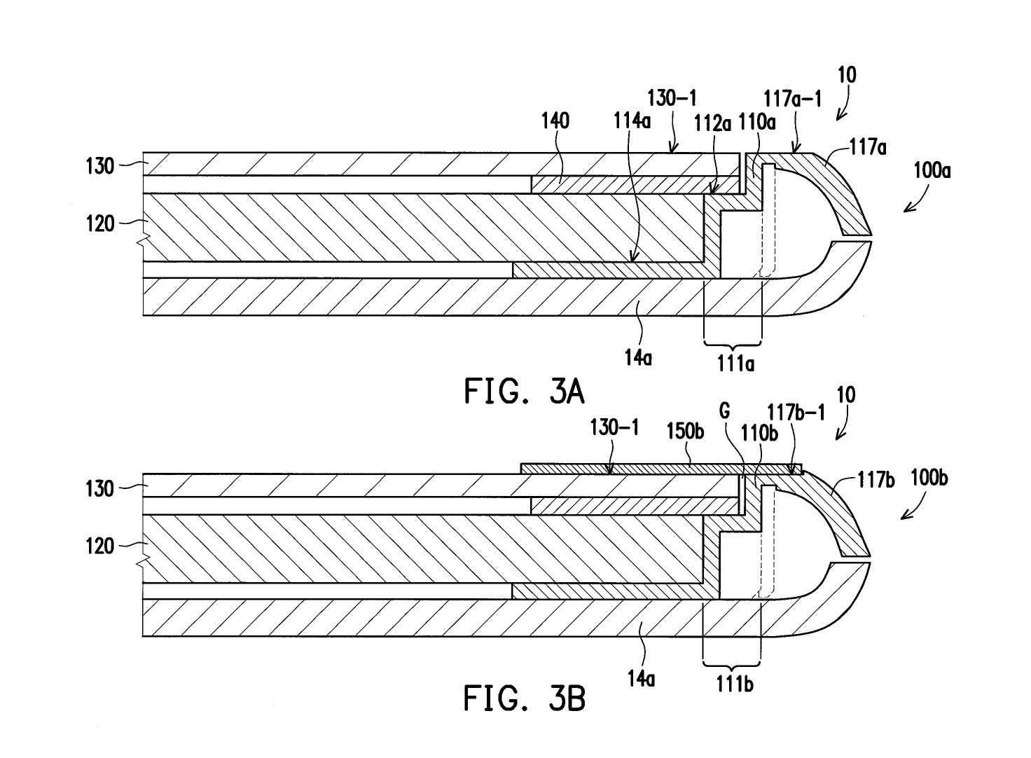

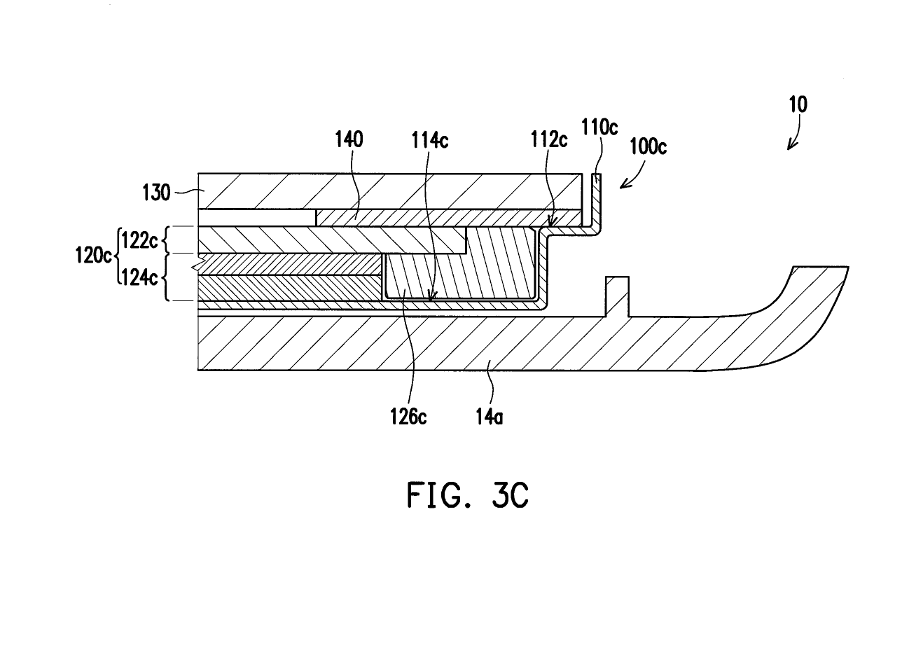

FIG. 3A is a schematic diagram of a touch display module applied to the electronic apparatus according to another embodiment of the invention. With reference to FIG. 3A, in the present embodiment, a touch display module 100a is assembled to the back cover 14a of the electronic apparatus 10. Likewise, the touch unit 130 is supported on a first supporting surface 112a of the frame 110a of the touch display module 100a and adhered to the display unit 120 and the first supporting surface 112 using the adhesive layer 140. The display unit 120 is supported in the second supporting surface 114a of the frame 110a. Differing from the above embodiment, the frame 110a of the touch display module 100a illustrated in FIG. 3A further has an extension portion 117 extending from a first supporting portion 111a and structurally locked with the back cover 14a. Thereby, the frame 110a is capable of supporting the display unit 120 and the touch unit 130, and the extension portion 117 of the frame 110a may further substitute for the front bezel (e.g., the front bezel 14b illustrated in FIG. 1B) and serve as an appearance element. Additionally, the touch unit 130 has a touch surface 130-1, the extension portion 117a of the frame 110b has a frame surface 117a-1, and the touch surface 130-1 is flush with the frame surface 117a-1.

FIG. 3B is a schematic diagram of a touch display module applied to the electronic apparatus according to yet another embodiment of the invention. With reference to FIG. 3B, in the present embodiment, a touch display module 100b is assembled to the back cover 14a of the electronic apparatus 10. A first supporting portion 111 of a frame 110b of the touch display module 100b likewise has an extension portion 117b substituting for the front bezel (e.g., the front bezel 14b illustrated in FIG. 1B) and serve as an appearance element. Differing from the touch display module 100a illustrated in FIG. 3A, the touch display module 100b of the present embodiment further includes a decorative sheet 150b attached onto the touch unit 130 and the frame 110b. To be more specific, the touch unit 130 has a touch surface 130-1, the extension portion 117b of the frame 110b has a frame surface 117b-1, the touch surface 130-1 is flush with the frame surface 117b-1, and the decorative sheet 150b is attached to the touch surface 130-1 and the frame surface 117b-1. In the present embodiment, the decorative sheet 150b is capable of covering a gap G between the touch unit 130 and the frame 110b to maintain an aesthetic appearance. Additionally, the decorative sheet 150b may have different appearance designs according to design demands, but the invention is not limited thereto. Additionally, in the embodiments illustrated in FIG. 3A and FIG. 3B, the structural designs of the frames 110a and 110b are similar to that of the frame 110, and will not be repeatedly described hereinafter.

FIG. 3C is a schematic diagram of a touch display module applied to the electronic apparatus according to still another embodiment of the invention. With reference to FIG. 3C, in the present embodiment, a touch display module 100c is assembled to the back cover 14a of the electronic apparatus 10. A frame 110c of the touch display module 100c likewise has a first supporting surface 112c for supporting the touch unit 130 and a second supporting surface 114c for supporting the display unit 120c. The display unit 120c includes a display panel 122c and a backlight module 124c. The display panel 122c is adhered to the touch unit 130 using the adhesive layer 140. The backlight module 124c is assembled to the display panel 122c and supported on the second supporting surface 114c. In the present embodiment, the frame 110c may be made of a metal material to have better rigidity, while the backlight module 124c includes elements, such as a light-guiding plate, an optical film set, a light source and so on. Thus, the backlight module 124c of the display unit 120c may be directly disposed in the frame 110c, and only an inner frame 126c requires to be disposed in the backlight module 124c to support the display panel 122c, wherein the inner frame 126c may be made of a plastic material. The display panel 122c, the backlight module 124c and the inner frame 126c may be entirely surrounded by the frame 110c, such that the backlight module 124c does not have to be additionally disposed with a frame body, and the production cost can be reduced.

To sum up, in the electronic apparatus of the invention, the display unit and the touch unit of the touch display module can be fixed together by a single frame. The display unit is supported on the second supporting surface of the frame, the touch unit is supported on first supporting surface, and the touch unit, the display unit and the first supporting surface are adhered to one another, such that tolerance accumulation of the of the touch display module of the invention during the assembly process can be decreased to reduce an offset amount of the assembly. The frame of the touch display module can be disposed with the reinforcing ribs according design demands to advance the frame strength, and thereby, the electronic apparatus does not any additional reinforcing element to improve the rigidity of the touch display module. Additionally, the frame can be further extended to the outer of the electronic apparatus to serve as the appearance element, and thus, the electronic apparatus does not need to be disposed with any front bezel. Moreover, when the frame is made of a metal material, the backlight module of the display unit may be further directly disposed inside the frame, and therefore, the frames required for supporting backlight module which are typically disposed in the display unit in the conventional art are no longer required.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch display module, suitable for being assembled to a back cover of an electronic apparatus, comprising:
a frame having a first supporting surface and second supporting surface;
a display unit supported on the second supporting surface; and
a touch unit supported on the first supporting surface and adhered to the display unit and the first supporting surface, wherein the display unit is held between the second supporting surface and the touch unit.

2. The touch display module according to claim 1, wherein the frame comprises:
a first supporting portion having an accommodating slot, wherein the first supporting surface is located on the first supporting portion, and the display unit is located in the accommodating slot; and
a second supporting portion connected with the first supporting portion and located in the accommodating slot, wherein the second supporting surface is located on the second supporting portion.

3. The touch display module according to claim 2, wherein the second supporting portion comprises an opening, the second supporting portion is held between the display unit and the back cover, such that the opening forms a buffer space.

4. The touch display module according to claim 2, wherein the frame further comprises:
a plurality of reinforcing ribs connected to a side surface of the first supporting portion; and
a plurality of fixing portions connected to side surface of the first supporting portion.

5. The touch display module according to claim 4, wherein the fixing portions further comprises:
at least one frame locking portion extending from the side surface of the first supporting portion and being suitable for being locked with at least one back cover locking portion of the back cover; and
at least one frame fastening portion extending from the side surface of the first supporting portion, wherein the touch display module is suitable for being fastened onto the back cover by the frame fastening portion.

6. The touch display module according to claim 2, wherein the frame further comprises an extension portion extending from first supporting portion and structurally locked with the back cover.

7. The touch display module according to claim 6, wherein the touch unit has a touch surface, the extension portion has a frame surface, and the touch surface is flush with the frame surface.

8. The touch display module according to claim 7, further comprising:
a decorative sheet attached to the touch surface and the frame surface.

9. The touch display module according to claim 1, further comprising:
an adhesive layer disposed on the touch unit, wherein the touch unit is adhered to the first supporting surface and the display unit using the adhesive layer.

10. The touch display module according to claim 1, wherein the display unit comprises:
a display panel adhered to the touch unit; and
a backlight module assembled to the display panel and supported on the second supporting surface.

11. The touch display module according to claim 1, wherein the electronic apparatus comprises a first body and a second body pivoted to the first body, and the second body comprises the back cover and the touch display module.
